(19) United States
(12) Patent Application Publication
(10) Pub. No.: US 2021/0331036 A1
(43) Pub. Date: Oct. 28, 2021

(54) FITNESS MAT

(71) Applicant: BOE TECHNOLOGY GROUP CO., LTD., Beijing (CN)

(72) Inventors: Shuping GAI, Beijing (CN); Changlin LENG, Beijing (CN); Xiao ZHANG, Beijing (CN)

(21) Appl. No.: 16/610,934

(22) PCT Filed: Apr. 8, 2019
(86) PCT No.: PCT/CN2019/081756

§ 371 Date: Nov. 5, 2019

(30) Foreign Application Priority Data
May 29, 2018 (CN) 201820816480.2

(51) Int. Cl. A63B 24/00; A63B 21/00

(52) U.S. Cl. CPC A63B 24/00; A63B 2230/08; A63B 2230/04; A63B 21/4037

(57) ABSTRACT

A fitness mat includes a main body, a control device and a display screen. The display screen is provided at a surface of the main body, and the display screen is connected with the control device. The display screen provided at the main body of the fitness mat provided by the present disclosure can replace electronic devices such as a mobile phone and a tablet computer, etc. When a user uses the fitness mat to exercise, a fitness video that the user needs is displayed by the display screen. The versatility of the fitness mat is realized, so that the usage of the fitness is convenient for the user.

This application claims priority to Chinese Patent Application No. 201820816480.2, filed May 29, 2018, the entire disclosure of which is incorporated herein by reference as part of the present application.

### TECHNICAL FIELD

Embodiments of the present disclosure relate to a fitness mat.

### BACKGROUND

With the improvement of living standards, people pay more and more attention to physical health. However, due to limitation of working time and living location, people usually choose family indoor exercise for fitness, and sport equipments commonly used in indoor exercise include a fitness mat, etc.

### SUMMARY

Embodiments of the present disclosure provides a fitness mat, which includes a main body, a control device and a display screen. The display screen is provided at a surface of the main body, wherein the display screen is connected with the control device.

For example, in some embodiments, the control device is provided in an interior part of the main body.

For example, in some embodiments, the display screen is a flexible display screen.

For example, in some embodiments, the display screen is provided at an end of the main body along a length direction of the main body.

For example, in some embodiments, the fitness mat further includes a second display screen. The second display screen is provided at a surface opposite to a surface at which the display screen provided, wherein the second display screen is connected with the control device and is a flexible display screen.

For example, in some embodiments, the fitness mat further includes a pressure sensor. The pressure sensor is connected with the control device.

For example, in some embodiments, the pressure sensor is provided in an interior part of the main body.

For example, in some embodiments, a quantity of pressure sensors is more than one, and a plurality of the pressure sensors is evenly distributed at the main body.

For example, in some embodiments, the fitness mat further includes a heart rate detection device. The heart rate detection device is connected with the control device, wherein a detection end of the heart rate detection device is provided at a surface of the main body.

For example, in some embodiments, the heart rate detection device is provided in an interior part of the main body.

For example, in some embodiments, the fitness mat further includes a sweat detection device. The sweat detection device is connected with the control device, wherein a detection end of the sweat detection device is provided at an upper surface of the main body and/or a lower surface of the main body.

For example, in some embodiments, the sweat detection device is provided in an interior part of the main body.

For example, in some embodiments, the detection end of the sweat detection device is provided at an end of the main body along a length direction of the main body.

For example, in some embodiments, the fitness mat further includes a voice interaction device. The voice interaction device is connected with the control device.

For example, in some embodiments, the voice interaction device is provided in an interior part of the main body.

For example, in some embodiments, the fitness mat further includes a wireless transmission device. The wireless transmission device is connected with the control device.

For example, in some embodiments, the wireless transmission device is provided in an interior part of the main body.

For example, in some embodiments, the fitness mat further includes a heart rate detection device and a sweat detection device. The heart rate detection device is connected with the control device, and the sweat detection device is connected with the control device, wherein the control device is configured to: receive a heart rate information from the heart rate detection device; and set a detection time interval of the sweat detection device based on the heart rate information.

For example, in some embodiments, the control device is configured to: set a detection time interval of the sweat detection device as a first preset time when the heart rate device detects that a heart rate of a user continues to be less than a first threshold within a certain period of time; and set the detection time interval of the sweat detection device as a second preset time when the heart rate device detects that a heart rate of a user continues to be greater than a second threshold within the certain period of time, wherein the second preset time is less than the first preset time.

For example, in some embodiments, the fitness mat further includes a voice interaction device and a sweat detection device. The voice interaction device is connected with the control device, and the sweat detection device is connected with the control device, wherein the control device is configured to: receive a sweat information from the sweat detection device; and control the sweat detection device to provide a voice indication, when the sweat information indicates that a electrolyte content of a sweat is below a electrolyte threshold, wherein the voice indication indicates that water needs to be replenished.

### BRIEF DESCRIPTION OF THE DRAWINGS

FIG. 1 is a structural schematic diagram of a fitness mat according to at least one of embodiments of the present disclosure;

FIG. 2 is a structural schematic diagram of electrical connection of a fitness mat according to at least one of embodiments of the present disclosure; and

FIG. 3 is a section view of electrical connection of a fitness mat according to at least one embodiment of the present disclosure, which shows a main body and a pressure sensor.

### DETAILED DESCRIPTION

In order to make objects, technical details and advantages of the embodiments of the present disclosure apparent, the technical solutions of the embodiments will be described in a clearly and fully understandable way in connection with the drawings related to the embodiments of the present disclosure. Apparently, the described embodiments are just a part but not all of the embodiments of the present disclosure. Based on the described embodiments herein, those skilled in the art can obtain other embodiment(s), without any inventive work, which should be within the scope of the present disclosure.

Unless otherwise defined, all the technical and scientific terms used herein have the same meanings as commonly understood by one of ordinary skill in the art to which the present disclosure belongs. The terms “first,” “second,” etc., which are used in the description and the claims of the present application for invention, are not intended to indicate any sequence, amount or importance, but distinguish various components. Also, the terms “comprise,” “comprising,” “include,” “including,” etc., are intended to specify that the elements or the objects stated before these terms encompass the elements or the objects and equivalents thereof listed after these terms, but do not preclude the other elements or objects. The phrases “connect”, “connected”, etc., are not intended to define a physical connection or mechanical connection, but may include an electrical connection, an electromagnetic connection or an optical connection, directly or indirectly.

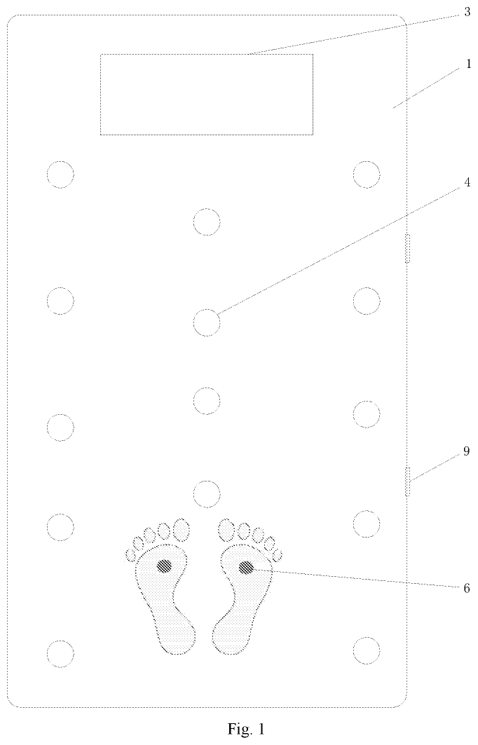

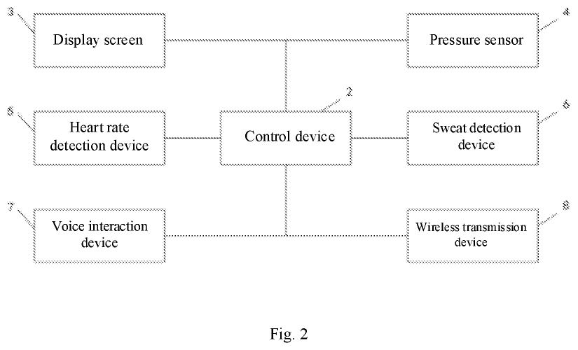

A fitness mat provided by at least one of embodiments of the present disclosure, as shown in FIG. 1 and FIG. 2, includes a main body 1, a control device 2 and a display screen 3. The control device 2 may be provided in an interior part of the main body 1. The display screen 3 may be provided at a surface of the main body 1, and the display screen 3 may be connected with the control device 2. When the control device 2 is provided in the interior part of the main body, usage of the fitness mat can become convenient. In other embodiments, the control device may further be provided in an exterior part of the main body 1.

The display screen provided on the main body of the fitness mat provided by the above embodiments of the present disclosure can replace a mobile terminal such as a mobile phone, a tablet computer, etc. When a user uses the fitness mat to exercise, a fitness video that the user needs is displayed by the display screen. The versatility of the fitness mat is realized, so that the usage of the fitness is convenient for the user. In addition, the control device provided in the fitness mat can control a display state and a display mode of the display screen. For example, the control device can control stop, start, pause, repeat paly, etc., of the video played in the display screen, and can be configured to select different videos to play, so that user's experience is improved, and learning of fitness exercises through the fitness mat is convenience for the user.

The main body 1 is a mat body of the fitness mat configured to carry the user. The main body 1 may be a mat of any shape, such as a rectangular mat. The main body 1 may be manufactured with a flexible material, such as a fiber material, a silicone material, etc. Under this condition, the body can be stored by winding, and the space that is occupied for storage is small. The main body 1 may further be provided with an anti-slip structure on a surface thereof according to the usage of the user, such as rubber anti-slip bumps. Magnitudes of thickness and area of the main body 1 are determined as desirable for the usage of the user, and the present disclosure is not specifically limited.

The control device 2 may be an electrical device for realizing control of display, such as selecting a video to be played in the display screen 3, and controlling speed, start, pause, etc., of play. The control device 2 may be, for example, a microcontroller, a field programmable gate array (FPGA) or an application specific integrated circuit (ASIC), etc.

The control device 2 may further include other control functions. For example, the control device 2 may control other devices configured to detect physical data of the user, such as a pressure sensor 4, a heart rate detection device 5, and a sweat detection device 6, etc., which are described below. For example, the control device 2 may collect the physical data of the user detected by these detection devices, and process the physical data of the user. Then, the processed physical data is displayed by controlling the display screen 3, so that the user knows his/her current physical condition.

The control device 2 may further provided with a memory such as a non-volatile memory (for example, a flash memory), a volatile memory (for example, a random access memory (RAM)), and other similar components to be able to store video data that needs to be displayed. The control device 2 may further be provided with a data connection device (such as a wireless transmission device 8 or a data transmission interface 9 which are described below). The data connection device can be, for example, configured to connect with an external electronic device, so that the control device 2 transmits the physical data of the user captured by the fitness mat to the electronic device, and controls graphic information displayed on the display screen 3 by the electronic device. Furthermore, the control device 2 can further access a network attached memory through, for example, the wireless transmission device 8. The electronic device may be, for example, a dedicated electronic device, a smart phone, a smart watch, a tablet computer, or a laptop computer, etc.

The display screen 3 can be a display screen including a touch control device, can be coupled with the control device 2 and can communicate with the control device 2 wirelessly or through a wire. The display screen 3 can interact with the control device 2 by a means of touch. The display screen 3 may further be a conventional display screen 3, that is, a screen that can only be used to display a video. In addition, the display screen 3 can have a certain compressive strength to avoid damage due to the pressure during use. The size of the display screen 3 may be set according to the area of the main body 1, and may be, for example, 5 inches or more. In addition, the main body 1 can further be provide with a sound amplifying device for playing sound, so that the user can hear a piece of audio synchronized with a video through the sound amplifying device while watching the video.

In other embodiments, the fitness mat includes an additional display screen and an additional control device. For example, the fitness mat may include the display screen 3 as a first display screen, and additionally includes a second display screen. The first display screen and the second display screen may be provided at opposite surfaces of the main body 1, respectively. Similar to the first display screen (that is, the display screen 3), the second display screen can display the fitness video needed by the user, and the control device 2 can control a specific display of the second display screen.

For example, the display screen 3 may be a flexible display screen 3.

Because the fitness mat is a kind of fitness equipments for indoor exercise, the main body 1 of the fitness mat needs to have characteristics of being bendable or foldable. The display screen 3 provided as the flexible display screen 3 can be deformed with the deformation of the main body 1 when the main body 1 is bent or folded, thereby facilitating accommodation of the fitness mat. In addition, the display screen 3 can adopt a transparent organic light-emitting diode (OLED) flexible screen, so that the display screen 3 can be blended with design elements of the main body 1 without affecting the aesthetic appearance of the fitness mat.

As shown in FIG. 1 and FIG. 2, further, the display screen 3 is provided at a first end of the main body 1 along a length direction of the main body 1, and the display screen 3 is provided at a surface of the main body 1.

The fitness mat may be single-sided for use, or may be double-sided for use. For the single-sided fitness mat, the display screen 3 may be provided at an upper surface of the main body 1 or a lower surface of the main body 1. For the double-sided fitness mat, the fitness mat may include the second display screen different from the display screen 3, and the display screen 3 and the second display screen may be provided at the upper surface of the main body 1 and the lower surface of the main body 1, respectively.

In addition, when users use the fitness mat, most of them are doing exercises such as yoga, tablet support, push-ups or sit-ups, etc. Because most of users are accustomed to elongated fitness mat, the display screen 3 is provided at the first end of the main body 1 along the length direction of the main body 1. Under this condition, when the user uses the fitness mat to exercise, the video displayed on the display screen 3 can be conveniently watched, and the user can exercise according to guidance of the video.

As shown in FIG. 1 and FIG. 2, in present embodiments, the fitness mat provided by the present disclosure further includes a pressure sensor 4 configured to detect magnitude of the pressure applied by the user. The pressure sensor 4 may be provided in the interior part of the main body 1, and is connected with the control device 2. The pressure sensor 4 can be a device that converts a pressure signal into an electronic signal.

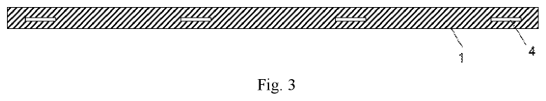

The pressure sensor 4 may be provided in the interior part of the main body 1, as shown in FIG. 3. The user uses the fitness mat to exercise, the pressure sensor 4 is capable of detecting the pressure that is acted on the main body 1 of the fitness mat by the user, and the change of the pressure with the movement of exercise. For example, the quantity of the push-ups by the user can be recorded by the pressure sensor 4. Also, the pressure sensor 4 can cooperate with the control device 4 to record the quantity of movements of the user, and to display the quantity of the movements on the display screen 3, so that the user can know his or her own exercise state whenever necessary. Further, the pressure that is acted on the main body 1 by the user can be detected by the pressure sensor 4 to obtain weight information of the user, and the weight information is recorded by the control device 2.

As shown in FIG. 1 and FIG. 2, further, the quantity of the pressure sensors 4 is more than one, and a plurality of the pressure sensors 4 is evenly distributed at the main body 1.

Because the user does not always act on some points of the fitness mat body 1 when using the fitness mat to exercise, and the user acts randomly on positions of points or portions of surfaces of the fitness mat, the pressure sensor 4 may be multiple and be evenly distributed, so that regardless any position where the user acts on the main body 1 of the fitness mat, the pressure sensors 4 can detect the magnitude of the pressure that is acted by the user and the change of the pressure.

As shown in FIG. 1 and FIG. 2, in the present disclosure, the fitness mat provided by the present disclosure may further include a heart rate detection device 5. The heart rate detection device 5 may be provided in an interior part of the main body 1, and is connected with the control device 2.

In other embodiments, the heart rate detection device 5 may further be provided in the exterior part of the main body 1.

For example, the heart rate detection device 5 may include a heart rate sensor. For example, the heart rate sensor can perform photoelectronic transmission measurement to get the heart rate information of the user based on the absorptive effect by blood on the light at a particular wavelength. For example, the heart rate sensor can further measure the heart rate information of the user by testing an electro cardio signal. The heart rate sensor can further measure the heart rate information of the user by other mechanisms.

A detection end of the heart rate detection device 5 is provided at a surface of the main body 1 for detecting the heart rate of the user. In some other embodiments, the detection ends of the heart rate detection device 5 may include two detection ends. The two detection ends may be respectively provided at an upper surface of the main body 1 and a lower surface of the main body 1 to allow the fitness mat to be used on both sides.

The heart rate detection device 5 is capable of detecting a heart rate change during the exercise of the user while performing statistics and recording a heart rate change by the control device 2. For example, the heart rate detection device 5 can transmit the heart rate information to the control device 2. The heart rate information of the user can further be displayed by the display screen 3, so that the user can know his/her heart rate during the exercise whenever necessary. For example, the control device 2 can process the heart rate information and then send processed heart rate information to the display screen 3. Therefore, the user can know intensity of the exercise through the change of the heart rate, and control the intensity of the exercise by monitoring the change of the heart rate to avoid any accident caused by excessive heart rate.

As shown in FIG. 1 and FIG. 2, in the embodiments, the fitness mat provided by the present disclosure further includes a sweat detection device 6. The sweat detection device 6 is provided in the interior part of the main body 1, and is connected with the control device 2. A detection end of the sweat detection device 6 is provided at a surface of the main body 1 for detecting amount of swearing of the user. In some other embodiments, the sweat detection device 6 may include two detection ends. The two detection ends may be respectively provided at an upper surface of the main body 1 and a lower surface of the main body 1 to allow the fitness mat to be used on both sides.

The sweat detection device 6 may include a sweat sensor. The working principle of the sweat sensor may be that, for example, when a human body sweats, the humidity of the surface of human skin increases, and a dielectric constant also increases. The non-contact electrode, that is the detection end, is configured to measure the capacitance change caused by sweating, and then the amount of sweating of the human body and the change of an electrolyte content of sweat can be calculated. By analyzing the data of different states of a human body, the physical condition of the human body can be further obtained, and the user is prompted to supplement water in time to maintain the normal state of the human body.

In some embodiments, during sweat detection, an adjustable detection cycle method can be adopted for realizing intelligent energy-saving detection. For example, when the heart rate detection device 5 detects that the heart rate V of a user continues to be maintained at a relatively low state less than a first threshold (V≤a1) within a certain period of time, the heart rate detection device detects sweat at an interval of a first preset time T1. For example, when the heart rate sensor detects that the heart rate V of the user continues to be maintained at a relatively high state greater than a second threshold (V>a2) within a certain period of time, the heart rate detection device detects sweat at an interval of a second preset time T2. In the embodiment, T2<T1. The first threshold a1 and the second threshold a2 may be equal, or the first threshold a1 may be greater than the second threshold a2. The control device 2 can perform the intelligent energy-saving detection by receiving the heart rate information of the heart rate detecting device 5 and setting the detection time interval of the sweat detecting device 6 (for example, the first preset time T1, the second preset time T2).

After collecting the amount of sweating and the electrolyte content of sweating, comprehensive analysis results are provided to the user, which is connection with age, height, weight, exercise intensity, ambient temperature, etc., of the user, to guide the user to better improve their physical condition and effect of fitness exercise. In the embodiments, the age, the height and the weight of the user can be stored in advance in the control device 2, and the ambient temperature can be measured by a temperature sensor provided in the main body 1.

As shown in FIG. 1 and FIG. 2, furthermore, the detection end of the sweat detection device 6 is provided at a second end of the main body 1 along the length direction of the main body 1. The second end is opposite to the first end.

The setting position of the sweat detection device 6 may be provided at another end of the main body 1 along the length direction of the main body 1 opposite to a setting position at which the display screen 3 is provided, that is, the second end. Under this condition, when the user uses the fitness mat to exercise, the user can place a foot at the second end of the main body 1 and place a hand or the head at the first end of the main body 1. At this time, the sweat detection device 6 can know the exercise condition of the user by detecting the sweat of the foot of the user, and the user can further know the result of the detection by watching the display screen 3 and watching the video.

As shown in FIG. 1 and FIG. 2, in the present embodiment, the fitness mat further includes a voice interaction device 7. The voice interaction device 7 may be provided, for example, in the interior part of the main body 1, and is connected with the control device 2. For example, the voice interaction device 7 may include an audio circuit, a speaker and a microphone. The speaker converts an electrical signal into a human audible sound wave, and the microphone converts the sound wave into an electrical signal. The audio circuit can convert the electrical signal from the microphone into input audio data, and transmit the audio data to the control device 2 for processing. For example, the speaker may be a sound amplifying device as described above.

The control device 2 can control the display screen 3, the pressure sensor 4, etc., based on the input audio data from the audio circuit. The control device 2 can further transmit output audio data to the audio circuit. The audio circuit converts the output audio data into the electronic signal, which is then converted via the speaker into a human audible sound wave, for example, words that inspires the user, such as “come on”, “holding on”, etc.

The voice interaction between the user and the fitness mat can be realized by the voice interaction device 7, for example, controlling the working state of the display screen 3 at the fitness mat, interactive networking, etc., by voice. The interaction between the fitness mat and the user can be realized.

As shown in FIG. 1 and FIG. 2, in the embodiments, the fitness mat further includes a data transmission interface 9. The data transmission interface 9 is provided at a side surface of the main body 1, and is connected with the control device 2. The control device 2 can communicate with another device via the data transmission interface 9. The data transmission interface 9 can be, for example, a universal serial bus (USB), a firewire, etc.

For example, other devices may include a storage device, for example, a hard disk. The data transmission interface 9 work to display video data or audio data in the hard disk through the display screen 3 on the main body 1 and the sound amplification device on the main body 1, respectively.

Moreover, in other embodiments, the data transmission interface 9 can further include an earphone interface.

As shown in FIG. 1 and FIG. 2, in the embodiments, the fitness mat further includes a wireless transmission device 8. The wireless transmission device 8 may be provided in the interior part of the main body 1. The wireless transmission device 8 is connected with the control device 2 for perform wireless communication between the control device 2 and another device. The wireless communication can be based, for example, on WIFI, Bluetooth, Bluetooth low energy (BLE), near field communication (NFC), infrared data transmission, mobile communication (such as third generation (3G) mobile communication, fourth generation (4G) mobile communication or fifth generation (5G) mobile communication), short-range wireless communication based on Zigbee protocol, etc. The wireless transmission device 8 may include a wireless transceiver.

The wireless transmission device 8 can implement wireless networking of the control device 2. For example, the wireless transmission device 8 can be wirelessly connected with the electronic device of the user, etc., thereby implementing control of the fitness mat through electronic devices such as a mobile phone and a tablet computer, and enabling the display screen 3 at the fitness mat to display fitness videos, guiding movements, or entertainment videos, etc., on the network. Further, requirements of the user are satisfied.

For example, the electronic devices may include an application-specific software, such as an application program. The application program can be programmed to set one or more of the display screen 3, the pressure sensor 4, the heart rate detection device 5, the sweat detection device 6, the voice interaction device 7, the wireless transmission device 8, or the data transmission interface 9 of the fitness mat by the control device 2, or to receive input data from the display screen 3 or detected physical data from the pressure sensor 4, the heart rate detection device 5, and the sweat detection device 6 by the control device 2.

In some embodiments, when the fitness mat is activated, the display device 3, the voice interaction device 7 and the pressure sensor 4 can be instantly turned on by the control device 2. The heart rate detection device 5 and the sweat detection device 6 can be turned on by touch, respectively. For example, the user can send a command to the control device 2 via the display device 3 or an electronic device to which the fitness mat is connected, and the control device 2 can turn on the heart rate detection device 5 or the sweat detection device 6 based on the command.

The control device 2 can set the detection time interval of the sweat detection device 6 based on the heart rate information from the heart rate detection device 5. For example, as described above, when the heart rate detection device 5 detects that the heart rate V of the user continues to be maintained at a relatively low state less than the first threshold (V≤a1) within a certain period of time, the heart rate detection device detects sweat at an interval of the first preset time T1. For example, as described above, when the heart rate sensor detects that the heart rate V of the user continues to be maintained at a relatively high state greater than the second threshold (V>a2) within a certain period of time, the heart rate detection device detects sweat at an interval of the second preset time T2. In the embodiment, T2<T1. Under this condition, energy consumption of the fitness mat can be effectively reduced.

The control device 2 can control the voice interaction device 7 based on the sweat information from the sweat detection device 6. For example, when the sweat information indicates that the electrolyte content of the sweat is below an electrolyte threshold, the control device 2 sends a command to the voice interaction device 7 such that the voice interaction device 7 provides a voice prompt indicating that he or she needs to supplement water. For example, the audio circuit in the voice interaction device 7 can retrieve pre-stored audio data based on the command from the control device 2, and convert retrieved audio data into an electrical signal and transmit the electrical signal to the speaker. The speaker can convert the electrical signal into a human audible sound wave to generate a piece of sound such as “please replenish water”, etc.

What are described above is related to the illustrative embodiments of the disclosure only and not limitative to the scope of the disclosure; the scopes of the disclosure are defined by the accompanying claims.

1. A fitness mat, comprising:
a main body;
a control device; and
a display screen, provided at a surface of the main body, wherein the display screen is connected with the control device.

2. The fitness mat according to claim 1, wherein the control device is provided in an interior part of the main body.

3. The fitness mat according to claim 1, wherein the display screen is a flexible display screen.

4. The fitness mat according to claim 3, wherein the display screen is provided at an end of the main body along a length direction of the main body.

5. The fitness mat according to claim 3, further comprising:
a second display screen, provided at a surface opposite to a surface at which the display screen provided,
wherein the second display screen is connected with the control device and is a flexible display screen.

6. The fitness mat according to claim 1, further comprising:
at least one pressure sensor, connected with the control device.

7. The fitness mat according to claim 6, wherein the at least one pressure sensor is provided in an interior part of the main body.

8. The fitness mat according to claim 6, wherein the at least one pressure sensor comprises a plurality of pressure sensors that are evenly distributed at the main body.

9. The fitness mat according to claim 1, further comprising:
a heart rate detection device, connected with the control device, wherein a detection end of the heart rate detection device is provided at a surface of the main body.

10. The fitness mat according to claim 9, wherein the heart rate detection device is provided in an interior part of the main body.

11. The fitness mat according to claim 1, further comprising:
a sweat detection device, connected with the control device, wherein a detection end of the sweat detection device is provided at an upper surface of the main body or a lower surface of the main body, or detection ends of the sweat detection device are provided at the upper surface of the main body and the lower surface of the main body, respectively.

12. The fitness mat according to claim 11, wherein the sweat detection device is provided in an interior part of the main body.

13. The fitness mat according to claim 11, wherein at least one detection end of the sweat detection device is provided at an end of the main body along a length direction of the main body.

14. The fitness mat according to claim 1, further comprising:
a voice interaction device, connected with the control device.

15. The fitness mat according to claim 14, wherein the voice interaction device is provided in an interior part of the main body.

16. The fitness mat according to claim 1, further comprising:
a wireless transmission device, connected with the control device.

17. The fitness mat according to claim 16, wherein the wireless transmission device is provided in an interior part of the main body.

18. The fitness mat according to claim 1, further comprising:
a heart rate detection device, connected with the control device; and
a sweat detection device, connected with the control device, wherein the control device is configured to:
receive a heart rate information from the heart rate detection device; and
set a detection time interval of the sweat detection device based on the heart rate information.

19. The fitness mat according to claim 18, wherein the control device is configured to:
set the detection time interval of the sweat detection device as a first preset time when the heart rate device detects that a heart rate of a user continues to be less than a first threshold within a certain period of time; and
set the detection time interval of the sweat detection device as a second preset time when the heart rate device detects that a heart rate of a user continues to be greater than a second threshold within the certain period of time, wherein the second preset time is less than the first preset time.

20. The fitness mat according to claim 1, further comprising:
a voice interaction device, connected with the control device, and
a sweat detection device, connected with the control device, wherein the control device is configured to:
receive a sweat information from the sweat detection device; and
control the sweat detection device to provide a voice indication, when the sweat information indicates that an electrolyte content of a sweat is below an electrolyte threshold, wherein the voice indication indicates that water needs to be replenished.
